(19) United States
(12) Patent Application Publication
(10) Pub. No.: US 2018/0336508 A1
(43) Pub. Date: Nov. 22, 2018

(54) RESOURCE GRID SYSTEM FOR TRACKING AND RECONCILING RESOURCE MOVEMENT

(71) Applicant: Bank of America Corporation, Charlotte, NC (US)

(72) Inventors: Kerry Michelle Cantley, Fort Mill, SC (US); David Joseph Koval, Charlotte, NC (US); Kristy Lynn Monk, Charlotte, NC (US); Keith Dion Owes, Bordentown, NJ (US); Brett C. Carter, Huntersville, NC (US); James Wayland Pierce, JR., Cornelius, NC (US); John Zemaitis, Charlotte, NC (US); Kim Leah Bunn, Saint Johns, FL (US); Sherri Sullivan, Newark, DE (US); Matthew Joseph Wallace, Media, PA (US); Veronica Smith, The Colony, TX (US)

(21) Appl. No.: 15/598,574

(22) Filed: May 18, 2017

(51) Int. Cl. G06Q 10/06; G06Q 10/08

(52) U.S. Cl. CPC G06Q 10/06311; G06Q 10/083

(57) ABSTRACT

Embodiments of the present invention provide a system for providing techniques, computer networks, and monitoring systems for managing and operating a nodal resource grid system in which resource notes are received, dispensed, and transferred throughout the nodal network. The nodal network may include or comprise automated teller machines, merchant stores, delivery vehicles, processing centers, and the like. The system scans resource notes for unique identifiers as they are received and/or dispensed at the nodes in real-time. These unique identifiers allow the system to track individual resource notes as they progress through the nodal network. The information about resource notes at each node can be recorded and stored in real-time, and information about the health of the network can be provided as visual representations to computing devices of a managing user.

### FIELD OF THE INVENTION

The present invention is generally directed to scanning, tracking, and reconciling resources throughout a nodal grid in real-time.

### BACKGROUND

Managing a network or grid of devices, entities, and delivery vehicles is a complex process, particularly when quantities of resources at each network node are critical to the health of the individual nodes and the overall network. Therefore, a need exists for particular techniques of providing a resource grid system for scanning, tracking, and reconciling resources throughout a network grid of devices, entities, and delivery vehicles in real-time.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing a resource grid system for tracking and reconciling resource movement. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve continuously monitoring a plurality of resource notes at a plurality of nodes across a physical geographic region, wherein the monitoring comprises (1) determining when each of the plurality of resource notes are received at each of the plurality of nodes and automatically scanning each of the plurality of resource notes for a unique identifier associated with each of the plurality of resource notes in real-time as they are received, wherein the unique identifier is associated with a unique characteristic and a denomination associated with each of the plurality of resource notes; (2) determining when each of the plurality of resource notes are dispensed at each of the plurality of nodes and automatically scanning each of the plurality of resource notes for the unique identifier associated with each of the plurality of resource notes in real-time as they are dispensed; and (3) storing monitored data for each of the plurality of nodes in a resource grid database, wherein the monitored data comprises nodal location data, time data associated with the received and the dispensed resource notes, unique identifier data for each of the received and the dispensed resource notes, and denomination data for each of the plurality of the received and the dispensed resource notes. Additionally, the system may automatically reconcile the monitored data for each of the plurality of nodes in real-time and provide a visual representation of the reconciled monitored data for each of the plurality of nodes to a computing device of a user.

In some embodiments, the system may also determine, from the scan of the plurality of resource notes for the unique identifier as they are received, that a first received resource note does not comprise a respective unique identifier. In response to determining that the first received resource note does not comprise the respective unique identifier, the system may extract identifiable data from the scan of the first received resource and apply the unique identifier to the first received resource note. In some such embodiments, applying the unique identifier comprises stamping, printing, or placing a number, a code, a text, an icon, or an image directly onto the first received resource note.

The visual representation of the reconciled monitored data for each of the plurality of nodes in the system may comprise a chart or coded map (e.g., a heat map or a color coded map) that visually represents amounts and quantities of resource notes at each of the plurality of nodes across the physical geographic region.

Additionally or alternatively, the visual representation of the reconciled monitored data for each of the plurality of nodes in the system may comprise a chart or coded map that visually represents a progression of an individual resource note of the plurality of resource notes across the plurality of nodes in the physical geographic region, based on the unique identifier associated with the individual resource note.

Furthermore, the system may include determining a trend of an amount of the plurality of resource notes that are present at a first node of the plurality of nodes over a period of time. Based on this trend, the system may also determine a predicted amount of the plurality of resource notes that are expected to be present at the first node at a future point in time. The system may then generate a visual representation of the determined predicted amount of the plurality of resource notes that are expected to be present at the first node at the future point in time.

In some embodiments of the system, each of the plurality of nodes comprise one or more automated teller machines, point of sale devices, mobile devices associated with users, delivery vehicles, or merchant locations.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A provides a block diagram illustrating a nodal network for tracking resources within the network, in accordance with an embodiment of the invention;

FIG. 1B provides a block diagram illustrating a system environment for tracking resources within a network, in accordance with an embodiment of the invention;

FIG. 2 provides a block diagram illustrating the managing entity system of FIG. 1B, in accordance with an embodiment of the invention;

FIG. 3 provides a block diagram illustrating the automated teller machine system of FIG. 1B, in accordance with an embodiment of the invention;

FIG. 4 provides a block diagram illustrating the mobile device system of FIG. 1B, in accordance with an embodiment of the invention;

FIG. 5 provides a block diagram illustrating the merchant system 500 of FIG. 1B, in accordance with an embodiment of the invention;

FIG. 6 provides a flowchart illustrating a process for providing a resource grid system for tracking and reconciling resource movement, in accordance with an embodiment of the invention; and

FIG. 7 provides a flowchart illustrating a process for providing a unique identifier to a resource note, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “managing entity” may refer to an entity, company, organization, or any other group or collection of entities that manages, monitors, owns, or otherwise controls one or more aspects of a resource grid network for identifying, storing, and tracking resources. In some embodiments, the managing entity is a financial institution with financial customers that are associated with or at least interact with one or more nodes within the resource grid network.

As used herein, the terms “resource,” “tangible resource,” “cash,” “bill,” “note,” “bank note,” “money,” and “currency,” may be interchangeable and may at least generally reference individual bank notes, coins, and/or other currency that may be traceable. As such, it should be known that embodiments that reference only “bank notes” may additionally or alternatively contemplate the inclusion of coins, checks, important documents (e.g., checks, contracts, and the like), and the like, or any combination thereof.

As used herein, the term “node” refers to a physical electronic device that is in network communication with one or more other nodes and/or a managing entity system (e.g., via a managing entity server), such that information may be generated, transmitted, received, encrypted, and the like, between the nodes and/or the managing entity system via network communication channels.

Generally, the systems, methods, and computer program products described herein provide techniques, computer networks, and monitoring systems for managing and/or operating a nodal grid in which resource notes (e.g., bank notes or cash) are received, dispensed, and transferred throughout the nodal network. The nodal network may comprise automated teller machines (ATMs), merchant stores, delivery vehicles (e.g., delivery trucks, armored vans, smart cars, cargo planes, and the like), processing centers, financial institution branches, and the like. The system scans resource notes for unique identifiers as they are received and/or dispensed at the nodes. These unique identifiers allow the system to track individual resource notes as they progress through the nodal network. The information about resource notes at each node can be recorded and stored in real-time, and information about the health of the network can be provided as visual representations to computing devices of a managing user.

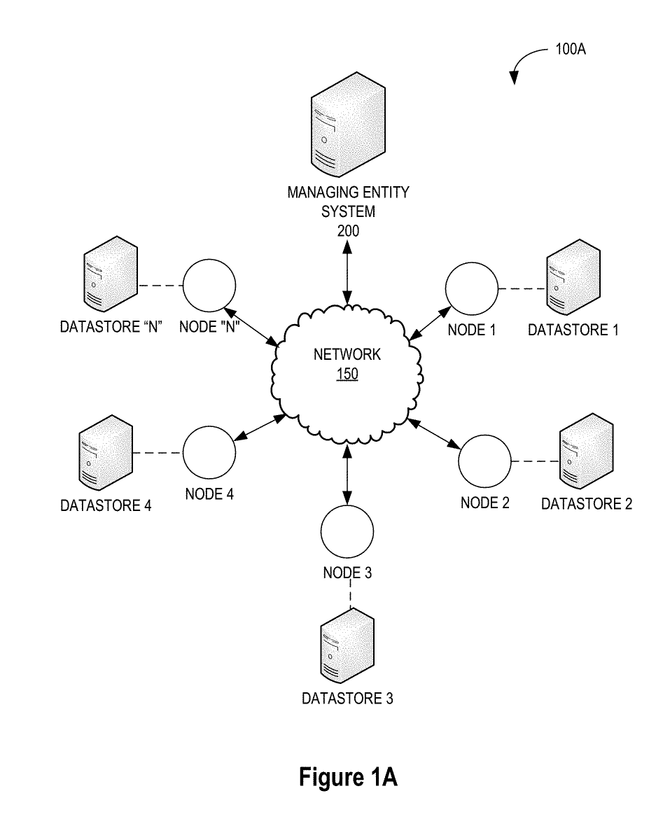

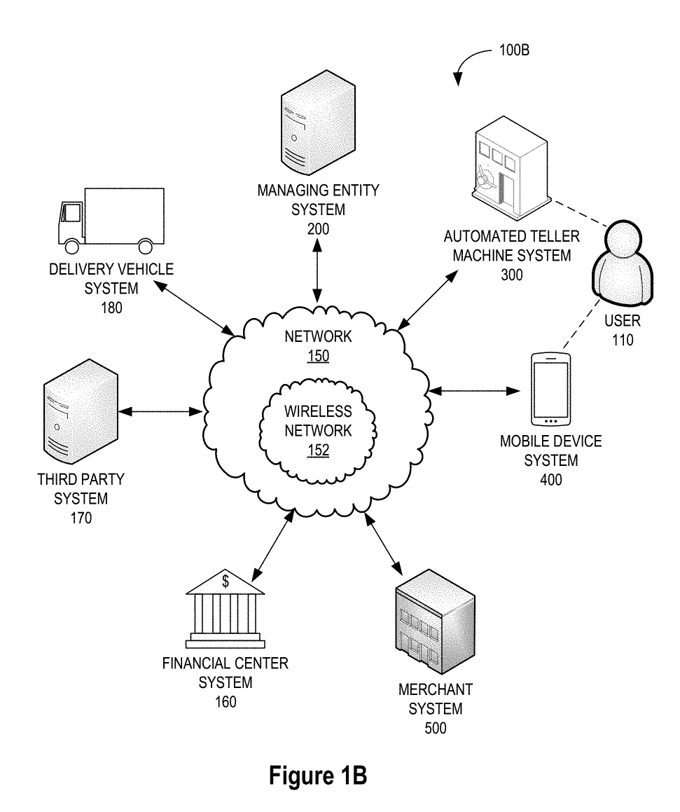

FIG. 1A provides a block diagram illustrating a network 100A for a resource network grid, in accordance with embodiments of the invention. As illustrated in FIG. 1A, the network 100A includes a managing entity system 200 and multiple nodes (Node 1, Node 2, Node 3, Node 4, through Node “N”). While five nodes are shown in FIG. 1A, it should be known that any number of nodes may be present. This may be represented by “Node N” in FIG. 1A, illustrating that there may be a total of “N” nodes in the system environment.

Nodes 1 through Node “N” may be configured to communicate with each other and/or a managing entity system 200 over a network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless network (e.g., a wireless telephone network).

As shown in FIG. 1A, the nodes in the network 100A may comprise or otherwise be in communication with one or more node datastores (e.g., Datastore 1, Datastore 2, Datastore 3, Datastore 4, through Datastore “N”). While FIG. 1A illustrates one datastore for each node, it should be known that each node may be associated with one or more datastores, and a single datastore may be associated with more than one node. For example, the managing entity system 200 may comprise a master datastore, such that information from each node may be transmitted to the managing entity system 200 and stored in the master datastore within the managing entity system. In such embodiments, nodal information may not be stored in datastores associated with each node. In some embodiments, nodal information for one node may be stored in multiple datastores within the system, thereby backing up the nodal information on separate datastores for security and validation purposes.

As described above, a node generally refers to a physical electronic device that is in network communication with one or more other nodes and/or a managing system. Examples of the electronic device comprising the node includes, but is not limited to, automated teller machines (ATMs), financial center systems (e.g., ATMs, point of sale (POS) devices, scanning devices, electronic safety deposit devices, cash vaults, other resource inventory locations, and the like), merchant systems (e.g., cash registers, vending machines, self-checkout devices, POS devices, electronic safes, scanning devices, and the like), delivery vehicle systems (e.g., mobile resource monitoring devices, and the like), mobile devices (e.g., mobile smart phones, mobile scanning devices, and the like). Of course, any other device or system can be considered a node, as long as it is configured to acquire, store, and/or transmit information to the managing entity system 200 and/or other nodes within the network 100A.

Additionally or alternatively, a node may refer to a physical location (e.g., a geographic location, a geographic region, a store or other building location, a non-electronic location like a safe, and the like). In such embodiments, one or more datastores may be associated with the physical locations, such that at least a portion of each datastore comprises information that is associated with contents of the physical location. For example, a datastore associated with a mobile scanning device used by a delivery vehicle driver may be associated with contents of an associated delivery vehicle, such that the datastore comprises information (e.g., real-time information and/or historical information) about contents of the delivery vehicle.

In some embodiments, the nodes (or electronic devices associated with the nodes), may be configured to track movement of resources (e.g., cash, bank notes, valuable items, and the like) throughout the network 100A. In some such embodiments, the nodes are configured to track individual bills, bank notes, and the like, across the network 100A to determine quantities and values of cash at each node at one or more points in time. By tracking the quantities and values of cash at each node in the network 100A over time (e.g., continuously in real-time, in near real-time, or periodically), a system can identify trends of the movement of cash throughout the network 100A.

Therefore, in some embodiments, individual cash bills (e.g., bank notes) are analyzed (e.g., as they are received, while they are stored, and/or as they are being dispensed or are otherwise leaving) at a node of the network 100A. For example, a bank note deposited at a node comprising a financial center may be scanned by a scanner of the financial center to ascertain identifiable information of the bank note.

The term identifiable information, as used herein, shall refer to any information that may be ascertained from a bank note to identify one or more of the following features: a bank note denomination, a coin denomination, a serial number, a date of printing or manufacture, a location of printing or manufacture, a weight, a metallic content, an ink type, a paper type, a security measure (e.g., a reflective characteristic, a watermark, and the like), a marking (e.g., an intentional marking or a general wear and tear marking), physical characteristics of the bank note, or any other information that identifies the bank note in some way and/or provides information about the authenticity of the bank note.

Any type of scanner may be used at a node, including scanners designed specifically to measure or otherwise ascertain one or more piece of identifiable information. For example, a scanner may be an optical camera, an infrared camera, a barcode scanner, a quick response (QR) code scanner, a radio frequency identification (RFID) tag scanner, a scale, an optical character recognition (OCR) device, a smartphone (or a component of a smartphone), and the like. Additionally or alternatively, identifiable information of one or more bank notes may be manually input into a node database by a user, merchant, employee of a financial institution, employee of a managing entity, and the like. For example, a user may manually input a denomination and serial number of a bank note before storing the bank note in an electronic safe.

The datastores (e.g., Datastore 1, Datastore 2, Datastore 3, Datastore 4, through Datastore “N”), may record the identifiable information for one or more bank notes associated with their respective nodes (Node 1, Node 2, Node 3, Node 4, through Node “N”, respectively). In this way, the network 100A can maintain a real-time, near real-time, and/or periodic point-in-time picture of the contents of each individual node in the network 100A and the contents of the network 100A as a whole. To accomplish the task of maintaining a survey of the node contents (and the network 100A as a whole), each datastore within the network 100A may record information that will enable the managing entity system 200 to monitor the node contents. Therefore, each datastore in the network 100A may store information associated with the denominations of bank notes located at its respective node, serial numbers (or other unique identifiers) of bank notes at its respective node, validity information (e.g., information associated with the confidence that the received or stored bank note is an authentic bank note), quality information (e.g., information associated with the structure, visibility, age, and the like of received or stored bank notes), and the like. In some embodiments, one or more datastores may provide a breakdown of bank notes that are associated with one or more nodes, one or more customers, and the like. For example, a node comprising a financial center system may associate each received bank note with one or more checking accounts, savings accounts, investing accounts, and the like for one or more customers of financial center system. In this way, the datastore of the financial center system node can store information about the total cash situation for the financial center system as well as information about sub-categories (e.g., users, accounts, and the like) within the financial center system. Furthermore, datastores associated with each node may store timing information about each received or scanned bank note to identify

In this way, the managing entity system 200 of the network 100A may be configured to monitor the identifiable information stored at each node to determine characteristics of the network 100A. For example, the managing entity system 200 can determine a total value of the bank notes accounted for in the network (e.g., located at each node, in transit between nodes, a cumulative total value for all nodes, and the like). The managing entity system 200 can also track one or more single bank notes (e.g., by tracking a serial number or other unique identifier of the single bank note) over time as the one or more bank notes progress through the network 100A.

By tracking individual bank notes through multiple nodes of the network 100A, the managing entity system 200 may be able to identify trends of the network as a whole as well as trends of each individual node. For example, the managing entity system 200 may be able to make determinations about when a node is likely to run low on cash. To illustrate this example, we can assume Node 1 is an ATM that is configured to accept deposits of cash and to dispense cash as customers of the managing entity desire. The managing entity system 200 may track a quantity of each denomination of bank note stored within a cash receptacle of Node 1, and/or a total value of the bank notes stored at the ATM of Node 1 over a period of time. Once the tracking of the quantity of each denomination of bank notes and/or the total value of bank notes stored at Node 1 dips below one or more predetermined threshold values, the managing entity system 200 may automatically transmit an alert or instructions to a delivery vehicle system or other system of the managing entity system 200 to provide additional bank notes (and, in some embodiments, a specific quantity of one or more bank notes and/or a specific total value of bank notes) to the ATM of Node 1 within a defined period of time to prevent the ATM from running out of available funds for withdrawal.

In some such embodiments, the managing entity system 200 may determine, based on tracking the identifiable information of bank notes stored at Node 1, a trend in the quantity of one or more denominations of bank notes and/or a total value of the bank notes stored at Node 1. In this way, the managing entity system 200 may extrapolate the trend to identify a point in time that the ATM of Node 1 should be refilled with new bank notes, as described above. By determining a trend of the bank note denomination quantity (or quantities) and/or the total value of Node 1, the managing entity system 200 can transmit instructions for refilling the ATM of Node 1 at a later point in time, to provide more time for a refilling system (e.g., a delivery driver and a delivery vehicle) to prepare for refilling, and to travel to the physical location of the ATM of Node 1. In this way, the managing entity system 200 can organize or adjust a delivery system schedule ahead of time, before a node runs low on available funds for dispensing.

The identifiable information of contents at a node can be tracked and/or associated with time of day, time of month, day of the week, holiday, and other calendar-based scenarios to predict how the amount of cash located at each node (as well as how much cash is transported between two or more nodes) can be expected to change at any given time. For example, the managing entity system 200 determine, based on historical data for each node, that financial center nodes of the network 100A tend to incur a significant decrease in the total amount of cash available near the end of each work week. As such, the managing entity system 200 can use the historical data of each financial center node to predict how much cash is expected to be dispensed at each respective node and thereby can plan to provide at least the respective predicted amount of cash for each node ahead of time.

The managing entity system 200 can also monitor the network 100A to identify inconsistencies, duplicate items, and other potential issues with one or more nodes in the network 100A. For example, the managing entity system 200 may determine that multiple nodes have identified a duplicate serial number for a bank note (i.e., a first node reports that a bank note with a specific serial number is securely stored in the physical location of the first node and a second node reports that a bank note with the same specific serial number is stored in the physical location of that second node.) This determination of multiple bank notes comprising the same serial number (or other unique identifying information) may inform the managing entity system 200 of a potential error, a potential malfeasance, or some other issue that should be addressed. In some embodiments, the managing entity system 200 may be configured to transmit one or more instructions (e.g., a command signal or other electronic signal) to an electronic device associated with one or more of the affected nodes in the network 100A, where the instructions are configured to cause the electronic device to shut down, change security protocols (e.g., require an additional level of authorization before withdrawal of cash, and the like), physically separate bank notes with duplicate serial numbers (e.g., place bank notes with a duplicate serial number somewhere in the network 100A in a separate compartment that is not part of dispensing activities of the node), and the like.

In some embodiments, the managing entity system 200 may track individual bank notes and is thereby able to identify potential cash purchases and other spending made by customers at a merchant node within the network 100A. For example, a managing entity may track a bank note at an ATM node by scanning the bank note for a serial number, determine that this specific bank note is withdrawn from the ATM node by a known customer, and at a later point in time identify the same bank note (i.e., by scanning the bank note to identify the same serial number) at a self-checkout device of a merchant node within the network 100A. The implication here is that the same user has conducted the cash transaction at a merchant store associated with the merchant node. Therefore, the managing entity system 200 may transmit an alert to the known customer (e.g., via a mobile device known to be associated with the known merchant, or the like), where the alert requests confirmation of the customer's purchase at the merchant node.

By tracking the cash flow from an ATM node to a merchant node within the network 100A, the managing entity can update information associated with the known customer's online banking data to include information associated with information received from the merchant node. For example, the merchant node may transmit product information, price information, merchant type information, time of transaction information, and the like to the managing entity system 200, and the managing entity system 200 may update historical transactional information of the known customer. This technique of tracking cash purchases enables a financial institution to provide a more robust account of the known customer's transactions over time than by using credit, debit, and online transactional information alone.

Furthermore, the techniques for tracking cash flow through the network (and particularly as associated with a known customer), allow a managing entity system 200 to provide incentive programs to the known customer based on the cash transactions of the known customer.

Turning now to FIG. 1B, a block diagram is provided, illustrating a system environment 100B, in accordance with one or more embodiments of the invention. As illustrated in FIG. 1B, the system environment 100 includes a managing entity system 200, an automated teller machine (ATM) system 300, a mobile device system 400, a merchant system 500, a financial center system 160, a third party system 170, and a delivery vehicle system 180. Additionally, the system environment 100 may comprise a user 110 that is interacting with the ATM system 300 and/or the mobile device system 400. The user 110 may represent a customer of the managing entity, a customer of a financial entity, and the like. While FIG. 1B illustrates a single user 110, it should be known that multiple users may be associated with the system environment 100B and/or the managing entity system 200. Furthermore, while the user 110 in FIG. 1B is associated with the ATM system 300 and the mobile device system 400, it should be known that the user 110 may additionally or alternatively be associated with the merchant system 500 (e.g., the user 110 may conduct one or more transactions with the merchant system 500), the financial center system 160 (e.g., the user 110 may conduct one or more deposits or transactions with the financial center system 160), the third party system 170, and/or the delivery vehicle system 180.

Additionally, while a single ATM system 300, mobile device system 400, merchant system 500, financial center system 160, third party system 170, and delivery vehicle system 180 are illustrated in FIG. 1B, it should be known that any number of each of these systems may be present in the system environment 100B.

In some embodiments, the nodes (i.e., Node 1 through Node “N”) of FIG. 1A include or are otherwise comprised of one or more of the systems illustrated in FIG. 1B (i.e., the ATM system 300, the mobile device system 400, the merchant system 500, the financial center system 160, the third party system 170, and/or the delivery vehicle system 180). In such embodiments, the managing entity system 200 may manage, control, monitor, or otherwise oversee the illustrated systems of FIG. 1B in the same manner as the managing entity system 200 engages with the nodes comprising the network 100A in FIG. 1A.

For example, in some embodiments, the managing entity system 200 is controlled by a managing entity with a presence across a geographical area. Within that geographical area, the managing entity may manage or otherwise exert some control over a plurality of ATM systems (e.g., ATM system 300) and financial center systems (e.g., financial center locations like the financial center system 160).

Additionally, the managing entity with control over the managing entity system 200 may have some relationship with multiple merchants systems 500 in the geographical region (e.g., the managing entity may have some agreement in place to receive transactional information from POS devices, self-checkout devices, and the like, at one or more merchant locations).

Furthermore, the financial entity may have a plurality of customers (e.g., the user 110 and other users within the system environment 100B) located within the geographical area. These customers may have accounts (e.g., financial accounts) with the financial entity, such that the financial entity can receive and record transactional information of each customer over time. These customers may also be associated with one or more mobile devices (e.g., the mobile device system 400) that may represent or otherwise be associated with a node in the system environment 100B. As such, the managing entity may provide one or more mobile device applications to a mobile device system 400 of each customer (e.g., the user 110), whereby the provided mobile device applications provide the mobile device system 400 and/or the customer with functionality to act as or supplement one or more nodes within the system environment 100B.

The managing entity system 200, the ATM system 300, the mobile device system 400, the merchant system 500, the financial center system 160, the third party system 170, and the delivery vehicle system 180 may be configured to communicate over a network 150. As described above, the network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless telephone network 152.

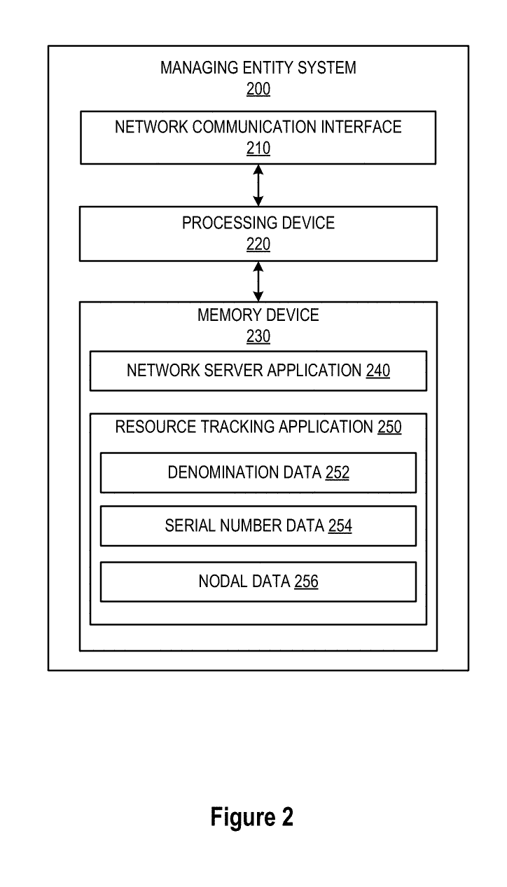

In general, the managing entity system 200 is in network communication with other devices, such as the ATM system 300, the mobile device system 400, the merchant system 500, the financial center system 160, the third party system 170, and/or the delivery vehicle system 180 via the network 150 to monitor traceable resources (e.g., cash, bank notes, and the like) across a network of nodes. The managing entity system 200 may be owned by, or otherwise controlled by a managing entity. This managing entity may be a financial entity, a security services entity, a government agency, or any other entity that can monitor individual bank notes across one or more nodes of a nodal network. The managing entity system 200 is described in more detail with respect to FIG. 2, below.

The ATM system 300 may comprise any computing device that is configured to receive cash deposits, store individual bank notes, scan individual bank notes, dispense one or more individual bank notes, interface with one or more customers, and communicate with one or more other systems via the network 150. While the ATM system 300 in FIG. 1B references an ATM, it should be known that the ATM system 300 may encompass multiple ATMS, one or more point of sale devices, a financial safe device, a cash vault, or any other computing device configured to perform functions of receiving cash, scanning cash, storing cash, and/or communicating with other systems via the network 150.

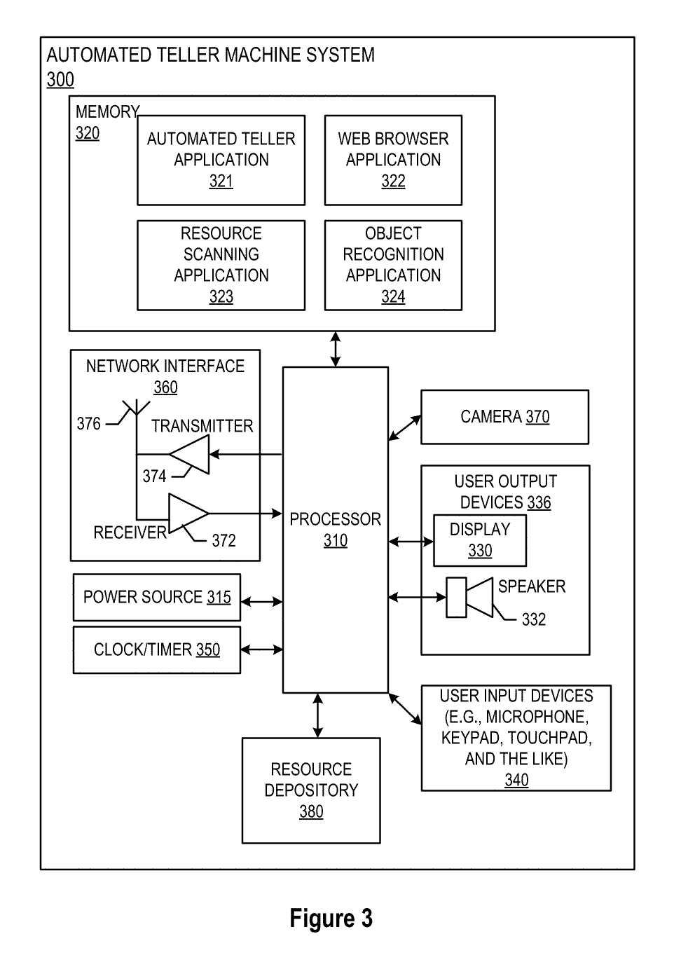

In some embodiments of the inventions, the ATM system 300 is simply configured to carry out the operations of the processes described herein, as instructed by the managing entity system 200 and/or a third party system 170. In other embodiments, the ATM system 300 is configured to provide the appropriate instructions as well as to carry out at least some of the operations necessary for the processes described herein. In some embodiments of the invention, at least a portion of the ATM system 300 is a component of the managing entity system 200. The ATM system 300 is described in greater detail with respect to FIG. 3, below.

The mobile device system 400 of FIG. 1B may be configured to connect with the network 150 to interface the user 110 or a different person with an application of the managing entity system 200, the ATM system 300, the merchant system 500, the financial center system 160, the third party system 170, and/or the delivery vehicle system 180. A user 110, in order to access the user's account(s), online banking application and/or mobile banking application on the managing entity system 300 may be required to provide authentication credentials to the managing entity system 200 and/or another system before the mobile device system 400 will complete one or more of the functions described herein. This authentication step will help the managing entity system 200 increase a confidence that the mobile device system 400 is acting at the request of the specific user 110 that the user 110 purports to be or represent. For example, logging into the managing entity system 200 generally requires that the user 110 authenticate his/her identity using a user name, a passcode, a cookie, a biometric identifier, a private key, a token, and/or another authentication mechanism that is provided by the user 110 to the managing entity system 200 via the mobile device.

The mobile device system 400 of FIG. 1B may be configured to carry out one or more of the nodal functions described with respect to the nodes of FIG. 1A. As such, the mobile device system 400 may be configured to scan bank notes, transmit identifiable information of the bank notes to the managing entity system 200 (or one or more other systems within the system environment 100B). In some embodiments, the mobile device system 400 can provide information that is to be related to a specific node. For example, the user 110 may scan in a serial number for a specific bank note using a camera of the mobile device system 400, and provide an input that the specific bank note should be associated with a node related to a merchant system 500.

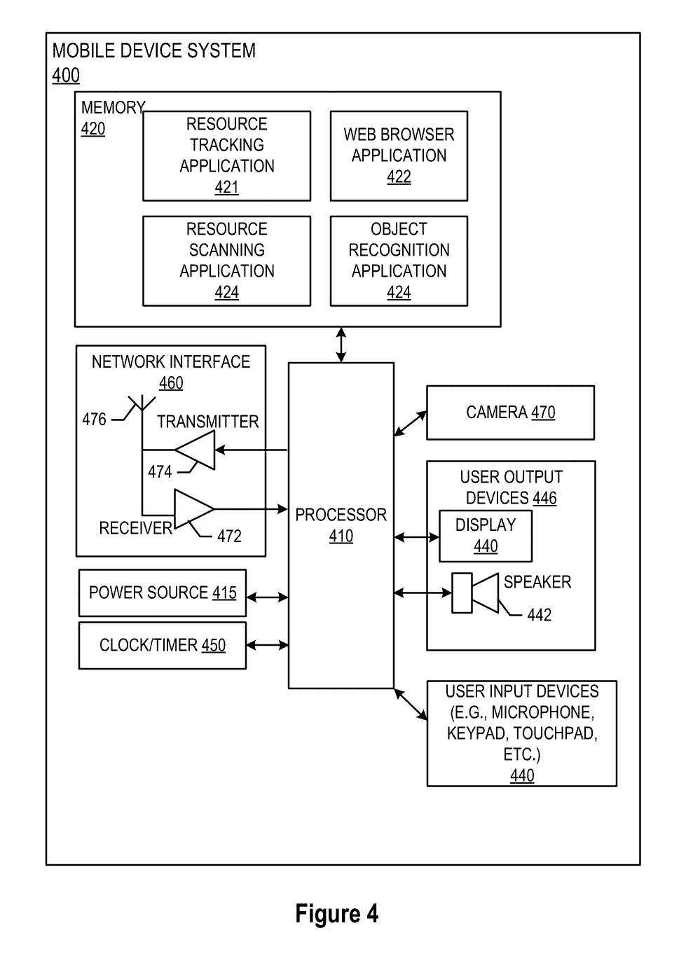

In other embodiments, the mobile device system 400 may represent a node closely related to a user 110. For example, a user 110 can be considered to have a cash assets that vary as the user 110 receives and spends cash. As such, the mobile device system 400 may be utilized by the user 110 to scan individual bank notes as they are received and/or transmitted (e.g., as part of a cash transaction). In this way, the mobile device system 400 may store information associated with at least some of the individual bank notes that likely are in the possession of the user 110 at any given point in time. By tracking user 110 nodes within the system environment 100B network, a managing entity can better track individual bank notes over time and better understand how the individual bank notes are used, processed, and transferred throughout the system environment 100B. The mobile device system 400 is described in more detail with respect to FIG. 4, below.

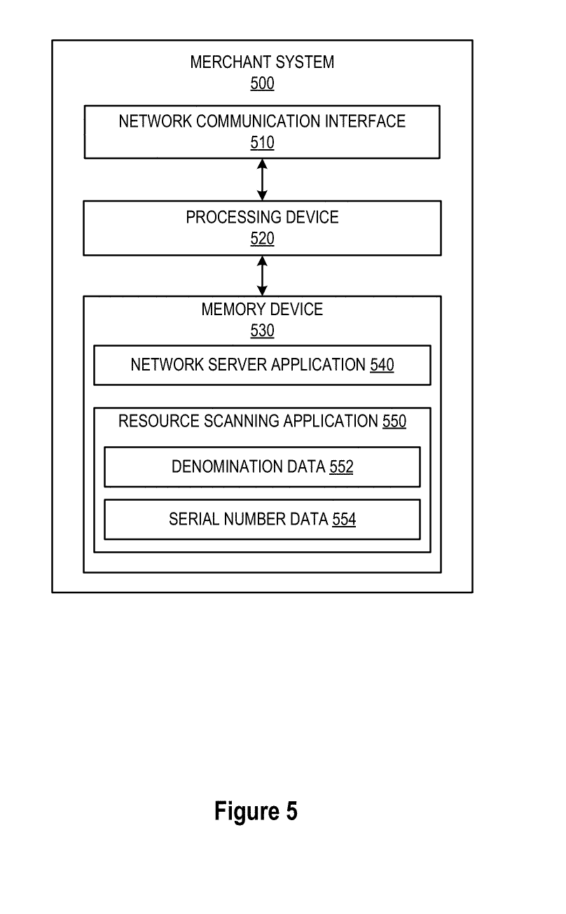

The merchant system 500 of FIG. 1B may be any system owned or otherwise controlled by a merchant entity and may include one or more devices associated with processing cash transactions, deposits, and the like. For example, a merchant system 500 may comprise one or more point of sale devices that are configured to scan individual bank notes as they are received. Additionally or alternatively, a merchant system 500 may comprise one or more self-checkout devices that are configured to receive cash payments from customers of the merchant, where the self-checkout devices are further configured to scan individual bank notes as they are received at the device. In some embodiments, the merchant system 500 may comprise a cash counting device that is configured to scan one or more individual bank notes (e.g., a merchant may process cash payments at least periodically through a cash counting device), such that information about the individual bank notes associated with the merchant system 500 may be identified, recorded, or otherwise monitored by the managing entity system 200. The merchant system 500 is described in more detail with respect to FIG. 5, below.

The financial center system 160 may comprise one or more cash processing centers or systems, one or more physical locations of a financial institution (e.g., a banking center), one or more centers or systems for validating the authenticity of bank notes, and/or the like. In some embodiments, the financial center system 160 may be a component of the managing entity system 200. For example, the managing entity may comprise a financial entity that owns or otherwise controls the financial center system 160.

Furthermore, the financial center system 160 may comprise one or more devices configured to scan, record, or otherwise acquire and store information associated with one or more individual bank notes, as the bank notes are received, processed, and/or dispensed.

The third party system 170 may be associated with one or more third party entities (e.g., a government agency, a regulatory agency, a financial institution, and the like). The third party system 170 may own or otherwise control one or more aspects of the system environment 100 (e.g., the ATM system 300, the financial center system 160, or the delivery vehicle system 180). Furthermore, in some embodiments, the third party system 170 may comprise one or more devices configured to scan, record, or otherwise acquire and store information associated with one or more individual bank notes, as the bank notes are received, processed and/or dispensed.

The delivery vehicle system 180 may be associated with one or more delivery vehicles (e.g., delivery trucks, armored vans, cargo planes, delivery drones, cargo ships, and the like) that pick up, deliver, and otherwise transfer resource notes between two or more nodes within the resource grid system 100B. In some embodiments, these delivery vehicles are considered nodes themselves (e.g., they are associated with a resource note scanning device, and the like). Furthermore, the delivery vehicles may comprise or be associated with global positioning system (GPS) devices, such that the managing entity system 200 can track the actual location of the delivery vehicles in real-time (or review historical location data of the delivery vehicles).

In some embodiments, the delivery vehicles of the delivery vehicle system 180 are configured to receive instructions or orders from the managing entity system 200, a third party system 170, and/or the merchant system 500 to pick up, deliver, or otherwise transfer sets of resource notes from one node of the resource grid network to another node (e.g., from one ATM to another ATM, from one merchant system to a financial center, and the like).

FIG. 2 provides a block diagram illustrating the managing entity system 200 of FIG. 1B in greater detail, in accordance with embodiments of the invention. As illustrated in FIG. 2, and in one embodiment of the invention, the managing entity system 200 includes one or more processing devices 220 operatively coupled to a network communication interface 210 and a memory device 230. In certain embodiments, the managing entity system 200 is operated by a managing entity, such as a financial institution, while in other embodiments, the managing entity system 200 is operated by an entity other than a financial institution.

It should be understood that the memory device 230 may include one or more databases, datastores, or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, resource tracking application 250 that includes denomination data 252, serial number data 254, and nodal data 256.

The computer-executable program code of the network server application 240 or the resource tracking application 250 may instruct the processing device 220 to perform certain logic, data-processing, and data-storing functions of the managing entity system 200 described herein, as well as communication functions of the managing entity system 200. For example, the managing entity system 200 may be configured to cause the network communication interface 210 to instruct (and/or receive feedback from) the ATM system 300, the mobile device system 400, the merchant system 500, the financial center system 160, and/or the third party system 170 to perform certain functions. In this way, the managing entity system 200 may be configured to cause the components of the system environment 100 to perform certain tasks such scanning received or stored individual bank notes, recording identifiable information for each individual bank note, and storing time-based data for bank notes received, stored, and/or transmitted by each system.

In one embodiment, the resource tracking application 250 includes denomination data 252, serial number data 254, and other nodal data 256. The denomination data 252 may comprise any information associated with techniques for identifying a denomination of a currency. For example, the denomination data 252 may comprise information about sizes, weights, coloring, physical features, artistic features, numerical features, and the like for each denomination of any number of currencies (including foreign currencies). In this way, the managing entity system 200 may be able to compare an input of received currency characteristics with the denomination data 252 to determine a denomination of the currency.

Similarly, the serial number data 254 may comprise a datastore of one or more known serial numbers of acquired currency, or currency once acquired. For example, the managing entity system 200 may store any identified serial number data 254 within the resource tracking application 250.

The denomination data 252 and/or the serial number data 254 may additionally be related to nodal data 256, or data associated with individual nodes of a nodal network. For example, the nodal data 256 may comprise information about a nodal system (e.g., an ATM system 300, a mobile device system 400, a merchant system 500, a financial center system 160, and/or a third party system 170). This information about a nodal system may comprise location information for one or more nodes, total value of bank notes or other cash stored at one or more nodes, quantities of one or more denominations of bank notes for one or more nodes, historical data for one or more nodes, trend information for one or more nodes, and the like. In this way, the managing entity system 200 may be able to identify a serial number for each item of currency (i.e., each bank note) that it has in possession at each node in a nodal network.

As used herein, a “communication interface” generally includes a modem, server, transceiver, and/or other device for communicating with other devices on a network, and/or a user interface for communicating with one or more customers. The network communication interface 210 is a communication interface having one or more communication devices configured to communicate with one or more other devices on the network 150, such as the ATM system 300, the mobile device system 400, the merchant system 500, the financial center system 160, and/or the third party system 170. The processing device 220 is configured to use the network communication interface 210 to transmit and/or receive data and/or commands to and/or from the other devices connected to the network 150.

FIG. 3 provides a block diagram illustrating at least a portion of the automated teller machine (ATM) system 300 of FIG. 1B in more detail, in accordance with embodiments of the invention. The ATM system 300 may comprise multiple ATMs, point of sale transaction devices, self-checkout devices, financial safe devices, or any other computing devices configured to scan, record, store, and/or dispense bank notes, other currency, or other important items. However, for the sake of simplicity, the ATM system 300 will be described with respect to FIG. 3 as a single ATM.

Some embodiments of the automated teller machine system 300 include a processor 310 communicably coupled to such devices as a memory 320, user output devices 336, user input devices 340, a network interface 360, a power source 315, a clock or other timer 350, a camera 370, and/or a resource depository 380. The processor 310, and other processors described herein, generally include circuitry for implementing communication and/or logic functions of the automated teller machine system 300. For example, the processor 310 may include a digital signal processor device, a microprocessor device, and various analog to digital converters, digital to analog converters, and/or other support circuits. Control and signal processing functions of the automated teller machine system 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the automated teller machine system 300 to transmit and receive web content, such as, for example web page content, according to a Wireless Application Protocol (WAP), Hypertext Transfer Protocol (HTTP), and/or the like.

The processor 310 is configured to use the network interface 360 to communicate with one or more other devices on the network 150. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. The signals may include signaling information in accordance with the air interface standard of the applicable cellular system of the wireless telephone network 152. In this regard, the automated teller machine system 300 may be configured to operate with one or more air interface standards, communication protocols, modulation types, and access types. By way of illustration, the automated teller machine system 300 may be configured to operate in accordance with any of a number of first, second, third, and/or fourth-generation communication protocols and/or the like. For example, the automated teller machine system 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The automated teller machine system 300 may also be configured to operate in accordance with non-cellular communication mechanisms, such as via a wireless local area network (WLAN) or other communication/data networks. Of course, the network interface 360 may also comprise a wireline connection to at least a portion of the network 150.

As described above, the automated teller machine system 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the automated teller machine system 300 to receive data from a user such as the user 110, may include any of a number of devices allowing the automated teller machine system 300 to receive data from the user 110, such as a keypad, keyboard, touch-screen, touchpad, microphone, mouse, joystick, other pointer device, button, soft key, and/or other input device(s). The user interface may also include a camera 370, such as a digital camera.

The automated teller machine system 300 further includes a power source 315, such as a battery or power line, for powering various circuits and other devices that are used to operate the automated teller machine system 300. Embodiments of the automated teller machine system 300 may also include a clock or other timer 350 configured to determine and, in some cases, communicate actual or relative time to the processor 310 or one or more other devices.

The automated teller machine system 300 also includes a memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the automated teller machine system 300 and/or one or more of the process/method steps described herein. For example, the memory 320 may include such applications as an automated teller application 321, a conventional web browser application 322, a resource scanning application 323, and/or an object recognition application 324. These applications also typically provide a graphical user interface (GUI) on the display 330 that allows the first user 110 to communicate with the automated teller machine system 300, the financial institution system 300, and/or other devices or systems.

The memory 320 can also store any of a number of pieces of information, and data, used by the automated teller machine system 300 and the applications and devices that make up the automated teller machine system 300 or are in communication with the automated teller machine system 300 to implement the functions of the automated teller machine system 300 and/or the other systems described herein. For example, the memory 320 may include such data as user authentication information, and the like.

The automated teller application 321 of the memory 320 may comprise instructions for causing components of the ATM system 300 to perform certain functions that relate to transactions, deposits, withdrawals, and other financial actions. For example, the automated teller application 321 may cause the user output devices 336 to output certain information to a user (e.g., the user 110) and/or allow a user to input information regarding a financial transaction by using the user input devices 340. A user may be able to deposit an amount of cash into the automated teller system by inserting bank notes and/or coins into the resource depository 380 of the ATM system 300. The automated teller application 321 may cause one or more components of the ATM system 300 to measure, track, and/or store the deposited bank notes and/or coins, and store this information in the memory 320 for later use.

The object recognition application 324 may instruct one or more components of the ATM system 300 to detect, measure, analyze, or otherwise identify information found on (or associated with) the deposited bank notes and/or coins. For example, the object recognition application 324 may cause the camera 370 to acquire an image of a received bank note, where the image can then be analyzed by the object recognition application 324 to identify one or more useful features of the received bank note. In some embodiments, the object recognition application 324 and/or the automated teller application 321 may be configured to identify denominations of received currency, serial numbers of received currency, and/or make determinations on the validity of received currency.

The resource scanning application 323 of the memory 320 may be configured to provide instructions to components of the ATM system 300 for collecting, scanning, and/or tracking one or more bank notes, coins, other currency, or other important documents. For example, the resource scanning application 323 may cause the camera 370 to scan one or more bank notes (e.g., as they are received, while they are stored in the resource depository 380, and/or as bank notes are dispensed), to store information from the scan within the memory 320, and/or transmit the scan to the managing entity system 200 so the managing entity system 200 can monitor the ATM system 300 as a node in a resource network.

FIG. 4 provides a block diagram illustrating at least a portion of the mobile device system 400 of FIG. 1B in more detail, in accordance with embodiments of the invention. In one embodiment of the invention, the mobile device system 400 comprises a mobile telephone. However, it should be understood that a mobile telephone is merely illustrative of one type of mobile device that may benefit from, employ, or otherwise be involved with embodiments of the present invention and, therefore, should not be taken to limit the scope of embodiments of the present invention. Other types of mobile devices may include portable digital assistants (PDAs), pagers, mobile televisions, gaming devices, laptop computers, video recorders, audio/video players, radios, global positioning system (GPS) devices, mobile tablet computers, wearable devices, smartwatches, or any combination of the aforementioned.

The mobile device system 400 may comprise multiple mobile devices and/or multiple types of mobile devices. However, for the sake of simplicity, the mobile device system 400 will be described with respect to FIG. 4 as a single mobile device.

Some embodiments of the mobile device system 400 include a processor 410 communicably coupled to such devices as a memory 420, user output devices 436, user input devices 440, a network interface 460, a power source 415, a clock or other timer 450, and/or a camera 470. The processor 410, and other processors described herein, generally include circuitry for implementing communication and/or logic functions of the mobile device system 400. For example, the processor 410 may include a digital signal processor device, a microprocessor device, and various analog to digital converters, digital to analog converters, and/or other support circuits. Control and signal processing functions of the mobile device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device system 400 to transmit and receive web content, such as, for example web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless telephone network 152. In this regard, the mobile device system 400 may be configured to operate with one or more air interface standards, communication protocols, modulation types, and access types. By way of illustration, the mobile device system 400 may be configured to operate in accordance with any of a number of first, second, third, and/or fourth-generation communication protocols and/or the like. For example, the mobile device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The mobile device system 400 may also be configured to operate in accordance with non-cellular communication mechanisms, such as via a wireless local area network (WLAN) or other communication/data networks. Of course, the network interface 460 may also comprise a wireline connection to at least a portion of the network 150.

As described above, the mobile device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device system 400 to receive data from a user such as the user 110, may include any of a number of devices allowing the mobile device system 400 to receive data from the user 110, such as a keypad, keyboard, touch-screen, touchpad, microphone, mouse, joystick, other pointer device, button, soft key, and/or other input device(s). The user interface may also include a camera 470, such as a digital camera.

The mobile device system 400 further includes a power source 415, such as a battery or power line, for powering various circuits and other devices that are used to operate the mobile device system 400. Embodiments of the mobile device system 400 may also include a clock or other timer 450 configured to determine and, in some cases, communicate actual or relative time to the processor 410 or one or more other devices.

The mobile device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device system 400 and/or one or more of the process/method steps described herein. For example, the memory 420 may include such applications as a resource tracking application 421, a conventional web browser application 422, a resource scanning application 423, and/or an object recognition application 424. These applications also typically provide a graphical user interface (GUI) on the display 430 that allows the first user 110 to communicate with the managing entity system 200, the ATM system 300, other mobile device systems 400, the merchant system 500, the financial center system 160, and/or a third party system 170.

The memory 420 can also store any of a number of pieces of information, and data, used by the mobile device system 400 and the applications and devices that make up the mobile device system 400 or are in communication with the mobile device system 400 to implement the functions of the mobile device system 400 and/or the other systems described herein. For example, the memory 420 may include such data as user authentication information, and the like.

The resource tracking application 421 of the memory 420 may comprise instructions for causing components of the mobile device system 400 to perform certain functions that relate to transactions, savings, accounting, and other financial actions. For example, the resource tracking application 421 may cause the user output devices 436 to output certain information to a user (e.g., the user 110) and/or allow a user to input information regarding a financial transaction by using the user input devices 440. The resource tracking application 421 may cause one or more components of the mobile device system 400 to measure (e.g., scan) and/or track bank notes and/or coins provided by the user, and store this information in the memory 420 for later use.

The object recognition application 424 may instruct one or more components of the mobile device system 400 to detect, measure, analyze, or otherwise identify information found on (or associated with) bank notes and/or coins provided by the user. For example, the object recognition application 424 may cause the camera 470 to acquire an image of a received bank note, where the image can then be analyzed by the object recognition application 424 to identify one or more useful features of the received bank note. In some embodiments, the object recognition application 424 and/or the resource tracking application 421 may be configured to identify denominations of received currency, serial numbers of received currency, and/or make determinations on the validity of received currency.

The resource scanning application 423 of the memory 420 may be configured to provide instructions to components of the mobile device system 400 for collecting, scanning, and/or tracking one or more bank notes, coins, other currency, or other important documents. For example, the resource scanning application 423 may cause the camera 470 to scan one or more bank notes (e.g., as a user receives the currency, while the user has possession of the currency, and/or as the user transfers the currency), to store information from the scan within the memory 420, and/or transmit the scan to the managing entity system 200 so the managing entity system 200 can monitor the mobile device system 400 as a node in a resource network.

FIG. 5 provides a block diagram illustrating the merchant system 500 of FIG. 1B in greater detail, in accordance with embodiments of the invention. As illustrated in FIG. 5, and in one embodiment of the invention, the merchant system 500 includes one or more processing devices 520 operatively coupled to a network communication interface 510 and a memory device 530. In certain embodiments, the merchant system 500 is operated by a managing entity, such as a financial institution, while in other embodiments, the merchant system 500 is operated by an entity other than a financial institution.

It should be understood that the memory device 530 may include one or more databases, datastores, or other data structures/repositories. The memory device 530 also includes computer-executable program code that instructs the processing device 520 to operate the network communication interface 510 to perform certain communication functions of the merchant system 500 described herein. For example, in one embodiment of the merchant system 500, the memory device 530 includes, but is not limited to, a network server application 540, resource scanning application 550 that includes denomination data 552 and serial number data 554 associated with that merchant system 500. In some embodiments, each distinct merchant system 500 scans and records the denomination data 552, serial number data 554, and other identifiable information of received bank notes within its own memory device 530.

In one embodiment, the resource scanning application 550 includes denomination data 552, serial number data 554, and other nodal data 556. The denomination data 552 may comprise any information associated with techniques for identifying a denomination of a currency. For example, the denomination data 552 may comprise information about sizes, weights, coloring, physical features, artistic features, numerical features, and the like for each denomination of any number of currencies (including foreign currencies). In this way, the merchant system 500 may be able to compare an input of received currency characteristics with the denomination data 552 to determine a denomination of the currency.

Similarly, the serial number data 554 may comprise a datastore of one or more known serial numbers of acquired currency, or currency once acquired. For example, the merchant system 500 may store any identified serial number data 554 within the resource scanning application 550.

The denomination data 552 and/or the serial number data 554 may additionally be related to nodal data associated with the merchant system 500. In some embodiments, the nodal data is stored within the memory device 530 of the merchant system 500. Additionally or alternatively, and as described above, the nodal data may be stored in the memory device 230 of the managing entity system 200. This information about a nodal system may comprise location information for the merchant system 500, total value of bank notes or other cash stored at the merchant system 500, quantities of one or more denominations of bank notes for the merchant system 500, historical data for the merchant system 500, trend information for the merchant system 500, and the like. In this way, the merchant system 500 may be able to identify a serial number for each item of currency (i.e., each bank note) that it has in possession within the merchant system 500.

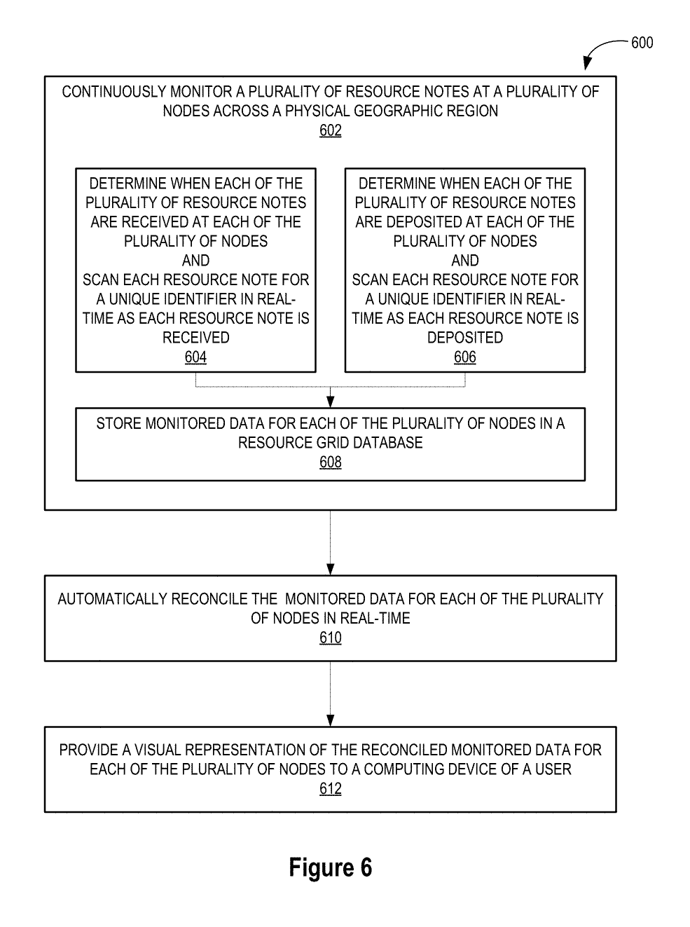

Referring now to FIG. 6, a flowchart is provided to illustrate one embodiment of a process 600 for providing a resource grid system for tracking and reconciling resource movement, in accordance with embodiments of the invention. In some embodiments, the process 600 may include block 602, where the system continuously monitors a plurality of resource notes at a plurality of nodes across a physical geographic region. As described above, the system may monitor interactions across multiple nodes that make up a nodal network of one or more geographic regions.

Additionally, and as described above, the term “node” may refer to any device, branch, entity, grouping of devices, branches, or entities, and the like within a geographic region. For example, the system may be associated with a nodal network made up of one or more automated teller machines (ATMs), point of sale devices, mobile devices associated with users, delivery vehicles, merchant stores or locations, electronic safes, cash vaults, other resource inventory locations, and/or the like. Therefore, the plurality of nodes at which the plurality of resource notes are monitored may comprise a local (e.g., city-wide) network of ATMs, financial institution branches, point of sale devices, merchant systems, delivery vehicles (e.g., armored delivery trucks or vans), and the like. Additionally or alternatively, the plurality of nodes may comprise or represent a much larger region (e.g., a region of a state, a region of a country, a region comprising at least portions of multiple countries, and the like).

The resource notes that are monitored within and across the plurality of nodes in this geographic region may comprise bank notes, checks, financial bonds, important documents or items, coins, or other currency or currency-based items.

As shown in FIG. 6, the continuously monitoring step of block 602 may further comprise block 604, block 606, and block 608. As such, in some embodiments, the process 600 includes block 604, where the system determines when each of the plurality of resource notes are received at each of the plurality of nodes and scans each resource note for a unique identifier in real-time as each resource note is received. In this way, the system is able to detect and identify resource notes (e.g., bank notes) as they are received at an ATM, a financial center, a delivery vehicle, a merchant location of a merchant system, or any other node within a monitored nodal network. Of course, in some embodiments, the resource notes are not identified immediately, but are processed in batches periodically (e.g., every hour, every few hours, every day, and the like). However, by immediately determining when the plurality of resources are received (e.g., by scanning the resource notes as they are received), and identifying information about the resource notes (e.g., the unique identifier) in real-time, the system is able to better track and account for the location and flow of resource notes within the overall nodal network.

The system may determine that a resource note is being received, or has been received, at a node by a detection from a detection device (e.g., a scanner, a scale, a camera, a cash deposit slot scanner, a point of sale device cash scanner, a self-checkout device cash scanner, and the like). As the resource note is detected, the system may immediately (or nearly immediately) cause a component device of the node to scan the received resource note for a unique identifier in real-time (or in near real-time).

In some such embodiments, the unique identifier may be associated with one or more unique characteristics of each received resource note and/or denomination data associated with each received resource note. For example, the unique identifier may be a unique serial number assigned to and already present on the resource note (e.g., a serial number placed on a bank note by the mint or treasury that generated the bank note). In another example, the unique identifier may be a security feature of the resource note, or at least a component of a security feature of the resource note. For example, the unique identifier may be incorporated in a water mark, an electromagnetic signal embedded within (or attached to) the resource note, a bar code affixed to the resource note, and the like.

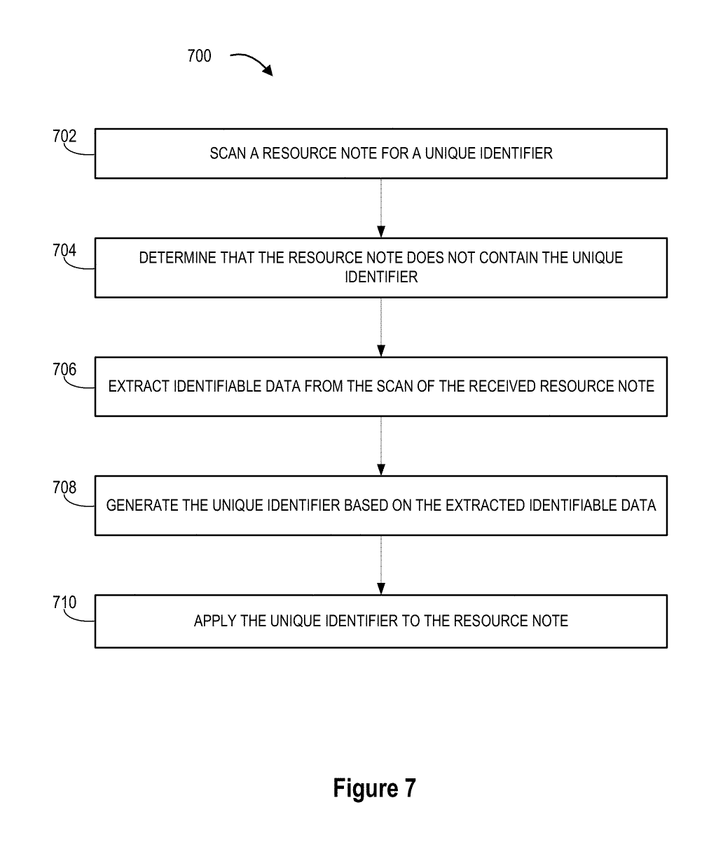

In some embodiments, the received resource note may not include or comprise a unique identifier. In such cases, the managing entity of the system may affix (or instruct a merchant or other nodal system of the overall nodal network system to affix) a new unique identifier on the resource note. A more detailed explanation and example of this process of providing a new unique identifier to a resource note can be found in the discussion with respect to FIG. 7, below.

By scanning and identifying unique identifiers as they are received by nodes of the nodal network, the system can determine when, how, and where each resource note has reached a destination, has been dispensed, has been used for payment, and the like. Additional information can be scanned or otherwise identified along with the unique identifier (or incorporated along with the scanned information about the unique identifier). For example, the system may time-stamp each scan of the resource note, identify a denomination of the resource note, and the like, and combine or otherwise reference the time information, the denomination information, information about the receiving node (e.g., a name of the node, a nodal type, a geographic location of the node, and the like), and other relevant information with the unique identifier for future reference.

Additionally, in some embodiments, the process 600 includes block 606, where the system determines when each of the plurality of resource notes are dispensed at each of the plurality of nodes and scans each resource note for a unique identifier in real-time as each resource note is dispensed.

In this way, the system is able to detect and identify resource notes (e.g., bank notes) as they are withdrawn from (or otherwise dispensed by) an ATM, a financial center, a delivery vehicle, a merchant location of a merchant system, or any other node within a monitored nodal network. By immediately determining when each of the plurality of resources are dispensed (e.g., by scanning the resource notes as they are withdrawn from a node), and identifying information about the resource notes (e.g., the unique identifier) in real-time, the system is able to better track and account for the location and flow of resource notes within the overall nodal network.

The system may determine that a resource note is being withdrawn, or has been withdrawn, at a node by a detection from a detection device (e.g., a scanner, a scale, a camera, a cash deposit slot scanner, a point of sale device cash scanner, a self-checkout device cash scanner, and the like). As the resource note is detected, the system may immediately (or nearly immediately) cause a component device of the node to scan the resource note for a unique identifier in real-time (or in near real-time). If a unique identifier does not exist, then the system may apply a new unique identifier to the resource note before the resource note is fully withdrawn from (or dispensed by) the node.

By scanning and identifying unique identifiers as they are dispensed by (or otherwise withdrawn from) nodes of the nodal network, the system can determine when, how, and where each resource note has been extracted from a destination, has been withdrawn, has been used for payment (e.g., given as change for a transaction), and the like. Additional information can be scanned or otherwise identified along with the unique identifier (or incorporated along with the scanned information about the unique identifier). For example, the system may time-stamp each scan of the resource note, identify a denomination of the resource note, and the like, and combine or otherwise reference the time information, the denomination information, information about the receiving node (e.g., a name of the node, a nodal type, a geographic location of the node, and the like), and other relevant information with the unique identifier for future reference.

The process 600 may also include block 608, where the system stores monitored data for each of the plurality of nodes in a resource grid database. The monitored data may comprise any data and/or information associated with the monitored nodes, the resource notes being identified and scanned at each of the nodes, and the like. For example, the monitored data may include, but is not limited to, nodal location data, time data associated with the received and dispensed resource notes, unique identifier data for each of the received and dispensed resource notes, and denomination data for each of the plurality of the received and dispensed resource notes.

This monitored data may be transmitted to, and stored in, a centralized resource grid database, where the managing entity can control, review, analyze, and otherwise monitor the monitored data in real-time as the data is acquired. The managing entity can also analyze historical monitored data in the resource grid database to identify trends, predict future flow of resource notes throughout the nodal grid, and the like.

Additionally or alternatively, at least some of the monitored data may be stored on local nodal databases that are in network communication with a managing entity system, such that the managing entity system can either receive data feeds form the local nodal databases in real-time (or near real-time), or the managing entity system can reach out to these remote nodal databases to review, analyze, extract, or otherwise monitor the data stored in the remote local nodal databases.

In some embodiments, the process 600 includes block 610, where the system automatically reconciles the monitored data for each of the plurality of nodes in real-time. Because the system is able to identify exactly when (or within a very short amount of time from when) a specific resource note, identified by its unique identifier, is present or is leaving each node of the nodal network, the system is able to reconcile accounts throughout the system associated with each node (or users, merchants, and the like associated with each node), reconcile transactions across or between nodes, and the like.

In such cases, the system does not need to wait for a processing center to perform an analysis of where a resource note came from and prove a report to the managing entity that a payment or other transaction has been received because the managing entity system already knows that the specific resource note(s) that were send from a first node have now been received at the processing center node.

For example, a user may wish to make a transaction that the managing entity knows about with a merchant that only accepts cash (e.g., a down payment for a vehicle, a rent payment, and the like). The system can monitor its nodes in the nodal network to identify when an ATM node has dispensed one or more bank notes in a withdrawal associated with a bank account of the user. Before (or as) the bank notes are dispensed, the system will scan the bank notes to identify unique identifiers for each bank note (e.g., the serial numbers for each bank note), and store this information in the resource grid database. As part of this interaction, the system may identify that at least the known transaction amount has been withdrawn from the ATM node by the user.

The system, as part of its continuous monitoring of the plurality of resource notes as they are received and dispensed at the nodes, may then determine that the merchant node is receiving one or more bank notes with the same serial numbers as those bank notes withdrawn by the user. In some embodiments, the system may additionally analyze time-stamped information about how long ago the user withdrew these same bank notes to determine whether it is likely that these bank notes came directly from the user. Once the system has at least a threshold level of confidence that the bank notes received by the merchant came from the user, and based on a determination that the received bank notes meet the transaction requirements (e.g., comprise a total value equal to the transaction amount), the system can at least tentatively reconcile the transaction and credit the merchant's account with the transaction payment. This can occur even before the merchant positively asserts that the transaction requirement has been met. In this way, the system can at least temporarily balance a balance sheet of the user, consider a transaction to be completed, and the like.

In some embodiments of the invention, the system may also provide predictive analytics, in some cases utilizing machine-based learning, to plan for future reconciliation of the monitored data at some future point in time, or over some future period of time. For example, the system may identify or determine a trend of an amount of the plurality of resource notes that are present at one or more nodes over a certain period of time. This trend may be determined through an analysis at each node regarding historical total amounts of resource notes at the node, historical total values of resource notes at the node, historical total quantities for each denomination of resource note, and the like, over multiple periods of time. The system may then use regression analysis to extrapolate expected amounts or values of the resource notes at one or more future points in time.

As such, the system may then determine, based on one or more trends, a predicted amount of the plurality of resource notes that are expected to be present at each of the one or more nodes at a future point in time. This understanding can aid the system in predicting and resolving potential cash flow, bank note flow, quantities of resource notes at certain nodes, and the like over time throughout the entire nodal network.

Finally, the process 600 may continue to block 612, where the system provides a visual representation of the reconciled monitored data for each of the plurality of nodes to a computing device of a user. As used herein, the term “user” may refer to an employee, contractor, or other individual associated with a managing entity that controls the system that operates the process 600. The computing device of the user may comprise a mobile device, a laptop computer, a personal computer, a pager, a specialized nodal network monitoring device, and the like.

In some embodiments, the visual representation of the reconciled monitored data for each of the plurality of nodes comprises a chart or color coded map that visually represents amounts and quantities of resource notes at each of the plurality of nodes across the physical geographic region. For example, nodes with resource note quantities that are within some high threshold amount of notes from maximum capacity may be illustrated in a color coded map as a red icon, nodes with resource note quantities that are below some low threshold amount of notes from a minimum capacity may be illustrated in a color coded map as a blue icon, while nodes with resource note quantities between the low and high threshold values may be represented as a green icon. A similar map or chart may be illustrated and color coded based on a percentage of resource notes between the minimum and maximum capacities of each resource note.

Furthermore, the visual representation of the reconciled monitored data may be interactive, such that quantities of resource notes, percentages of reaching the resource note capacity, quantities of resource notes broken down by denomination, and the like may be shown on the map of be presented in response to some input or request from the user (e.g., the user clicks on the icon associated with a node).

In some embodiments, the visual representation of the reconciled monitored data for each of the plurality of nodes comprises a chart or coded map that visually represents a progression of an individual resource note of the plurality of resource notes across the plurality of nodes in the physical geographic region, based on the unique identifier associated with the individual resource note. Because each individual resource note is scanned for its unique identifier, this unique identifier (and therefore the associated resource note) can be tracked as it is received and dispensed at each node within the nodal network. The system can analyze the time stamp data associated with each interaction with the nodes to track how and when the individual resource note is transferred throughout the nodal network. As such, the system can present a map that illustrates this progression, either as an informative image with time-based information for each transaction or as a video of the resource note as it travels throughout the nodal network over time.

Additionally or alternatively, the system may track progressions of multiple individual (and unique) resource notes as they progress through the nodal network. The system can then aggregate the data and compile information about how, when, and where the nodes tend to progress through the nodal network. For example, the system may be able to determine that resource notes withdrawn from a specific ATM are likely to be used at one or more merchants located physically near the specific ATM. This information can be visually represented as lines between the nodes of the system, with color coding or weighting of the lines indicating volume or frequency of specific resource note progression and arrows or other directional indicators showing which way the progression of resource notes tends to flow.

Overall, in embodiments where the system has determined predicted amounts of resource notes that are expected to be present at one or more nodes at a future point in time, the system may then generate a visual representation of the determined predicted amount of the plurality of resource notes that are expected to be present at the first node at the future point in time. For example, the user may operate a dial, sliding bar, or some other user input device on a user interface of the computing device to adjust the visual representation of the nodal network at different points in time, with the extrapolated and/or otherwise predicted values, quantities, or progressions at that specific point in time (e.g. a future point in time). In this way, the user is able to view a predicted health of the nodal network and order the transfer of certain amounts of resource notes to or away from one or more nodes in the nodal network before that node has too many or too few resource notes in its repository. Therefore, the visual representation of the nodal network provides a valuable function to the monitoring and adjusting resource nodes to maintain a healthy nodal network for the progression of resource notes throughout the nodal network.

Referring now to FIG. 7, a flowchart is provided to illustrate one embodiment of a process 700 for providing a unique identifier to a resource note, in accordance with embodiments of the invention. As described above, the process described herein for providing a new unique identifier may enable a managing entity to identify, track, and otherwise monitor individual resource notes as they progress through the nodal network. Being able to identify a an individual resource note at each node that the resource note progresses to allows a managing entity to monitor the flow of resource notes throughout the nodal network and to identify characteristics of how individual (and groups of individual) resource notes are spent, transferred, or otherwise moved throughout one or more geographic regions.

In some embodiments, the process 700 may include block 702, where the system scans a resource note for a unique identifier. As described above (e.g., with respect to block 604 and block 606 of the process 600 of FIG. 6), the system may be tracking resource notes as they are received and/or dispensed at nodes of an overall nodal network by scanning the resource notes as soon as they are detected. Of course, in other embodiments, the system may process the resource notes in periodic batches, where the resource notes are scanned on a periodic basis.

In some embodiments, the process 700 includes step 704, where the system determines that the resource note does not contain the unique identifier. Knowing the unique identifier of an individual resource note can be important to the monitoring system because this unique identifier allows the monitoring system to understand, on a note-by-note basis, when resource notes are received, processed, dispensed, in transit, and the like. Therefore, when the scan is unable to easily pick out the unique identifier of a resource note, the system can make a determination that either (i) no unique identifier exists on the resource note, or (ii) the unique identifier needs to be replaced (e.g., the unique identifier has been damaged, erased, manipulated, altered, or otherwise compromised).

The system may scan the individual resource note with a camera, a specialized resource note scanner, a cash scanner, an infrared scanner, an ultraviolet scanner, a weight scale, a dimensional measuring device, an electro-magnetic scanner, a near-field communication (NFC) scanner, a radio frequency identification (RFID) scanner, a barcode scanner, a quick response (QR) scanner, any combination of the above, or the like.

Additionally, in some embodiments, the process 700 includes block 706, where the system extracts identifiable data from the scan of the received resource note. This identifiable data may comprise any information about the physical resource note, text from the physical resource note, security features of the resource note, and the like, that may help the system identify or otherwise create a unique identifier. Depending on the type of scanning device used to scan the resource note, the system may need to conduct additional steps to extract the identifiable data. For example, while a weight scale may provide a specific weight data of the resource note, an optical character recognition (OCR) process may need to be implemented by a system that uses a camera to take and generate an image of the resource note. Continuing with the OCR example, the system may use the OCR process to extract alphanumerical denomination information about the resource note, serial number information about the resource note, text regarding a minting factory or location for the resource note, alphanumeric information regarding a date of minting the resource note, and the like. Of course, similar extractions may occur for the output of whichever scanning device is used by the system, such that the system is able to extract or otherwise identify the identifiable data of the resource note.

The process 700 may, in some embodiments, also include block 708, where the system generates the unique identifier based on the extracted identifiable data. In some embodiments, the generated unique identifier may simply be assigned to the resource note. For example, the system may have a pre-set progression of unique numbers, text, and/or codes that it applies to resource notes that do not already have unique identifiers on their face. In other embodiments, the system generates the unique identifier based on the extracted identifiable data. For example, the unique identifier may be based on an extracted serial number, the location of minting, and a date of minting, using an algorithm that ensures the resulting generated unique identifier is in fact unique to other serial number/location of minting/and date of minting combinations. Of course, these are merely examples of which types of information can be used and/or combined to generate a unique identifier for a resource note and they should not be viewed as limiting the described system to these specific examples.

While generating the unique identifier may, in some embodiments, comprise calculating or otherwise determining a set of numbers, text, and/or code that can be later put into a physical form (e.g., printed onto the resource note, printed onto a sticker that can be placed on the resource note, incorporated into an electro-magnetic scanning tag, and the like), the system may additionally or alternatively generate a physical unique identifier (or a physical component of a unique identifier) that can later be applied to the resource note. For example, the system may generate a stamp (e.g., adjust a physical stamping device to include the text, numbers, and/or code that will represent the unique identifier when stamped onto the resource note), a sticker comprising the unique identifier text, numbers, and/or code, and the like.

Finally, the process 700 may continue to block 710, where the system applies the unique identifier to the resource note. As mentioned above, the system may print the unique identifier onto the resource note. For example, the system may cause the resource note to be processed through a specialized unique identifier and/or resource note printing device that is configured to deposit ink (in some cases specialized, e.g., magnetic, ink) onto a specific location of the resource note that is associated with a location for the unique identifier to be located. By placing a unique identifier in a specific location on a resource note, subsequent scanning devices of nodes in the nodal system can be configured to scan that specific location of the resource note (instead of the entire resource note) to identify the unique identifier of the resource note. This saves time, memory, and processing power by only requiring enough scanning power and resources to scan the single location where the unique identifier is expected to be located instead of scanning and processing an image of an entire resource note. To this end, applying the unique identifier may further comprise applying the unique identifier to multiple locations of the resource note, such that a scanning device can always easily pick up the unique identifier, regardless of the direction or orientation of the resource note that is deposited.

In another example, the system may place a sticker or other unique identifier indicia (e.g., an NFC chip, an RFID tag, and the like) on the resource note. In some embodiments, two or more resource notes may be bundled together (or otherwise placed in a container) and a unique identifier is attached to the container, such that the contents of the container can be tracked throughout the nodal network. These additional types of unique identifiers that add more than ink to a resource note may be better suited for such a container, as they may adjust the readability or functionality of a resource note, but would not affect a container comprising resource notes as contents.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| | U.S. patent application | | |
|---|---|---|---|
| Docket Number | Ser. No. | Title | Filed On |
| 7639US1.014033.2975 | To be assigned | SYSTEM FOR | Concurrently |
| | | GENERATING AND | herewith |
| | | PROVIDING SEALED | |
| | | CONTAINERS OF | |
| | | TRACEABLE RESOURCES | |
| 7640US1.014033.2979 | To be assigned | SYSTEM FOR PROCESSING | Concurrently |
| | | RESOURCE DEPOSITS | herewith |
| 7736US1.014033.3017 | To be assigned | SYSTEM FOR PROVIDING | Concurrently |
| | | ON-DEMAND RESOURCE | herewith |
| | | DELIVERY TO RESOURCE | |
| | | DISPENSERS | |
| 7785US1.014033.3015 | To be assigned | SYSTEM FOR PROVIDING | Concurrently |
| | | REAL-TIME TRACKING OF | herewith |
| | | INDIVIDUAL RESOURCE | |
| | | ITEMS TO IDENTIFY | |
| | | SPECIFIC RESOURCE | |
| | | TRANSFERS | |
| 7796US1.014033.3018 | To be assigned | SYSTEM FOR PROVIDING | Concurrently |
| | | REAL-TIME TRACKING OF | herewith |
| | | INDIVIDUAL RESOURCE | |
| | | ITEMS TO IDENTIFY | |
| | | UNAUTHORIZED | |
| | | RESOURCE TRANSFERS | |
| 7800US1.014033.3016 | To be assigned | SYSTEM FOR PROCESSING | Concurrently |
| | | DEPOSIT OF RESOURCES | herewith |
| | | WITH A RESOURCE | |
| | | MANAGEMENT SYSTEM | |

1. A resource grid system for tracking and reconciling resource movement, the system comprising:
a memory device; and
one or more processing devices operatively coupled to the memory device, wherein the one or more processing devices are configured to execute computer-readable program code to:
monitor, continuously, a plurality of resource notes at a plurality of nodes across a physical geographic region, wherein monitoring comprises:
determining when each of the plurality of resource notes are received at each of the plurality of nodes and automatically scanning each of the plurality of resource notes for a unique identifier associated with each of the plurality of resource notes in real-time as they are received, wherein the unique identifier is associated with a unique characteristic and a denomination associated with each of the plurality of resource notes;
determining when each of the plurality of resource notes are dispensed at each of the plurality of nodes and automatically scanning each of the plurality of resource notes for the unique identifier associated with each of the plurality of resource notes in real-time as they are dispensed; and
storing monitored data for each of the plurality of nodes in a resource grid database, wherein the monitored data comprises nodal location data, time data associated with the received and the dispensed resource notes, unique identifier data for each of the received and the dispensed resource notes, and denomination data for each of the plurality of the received and the dispensed resource notes;
reconcile, automatically, the monitored data for each of the plurality of nodes in real-time; and
provide a visual representation of the reconciled monitored data for each of the plurality of nodes to a computing device of a user.

2. The system of claim 1, wherein the one or more processing devices are further configured to execute computer-readable program code to:
determine, from the scan of the plurality of resource notes for the unique identifier as they are received, that a first received resource note does not comprise a respective unique identifier;
in response to determining that the first received resource note does not comprise the respective unique identifier, extract identifiable data from the scan of the first received resource note; and
apply the unique identifier to the first received resource note.

3. The system of claim 2, wherein applying the unique identifier comprises stamping, printing, or placing a number, a code, a text, an icon, or an image directly onto the first received resource note.

4. The system of claim 1, wherein the visual representation of the reconciled monitored data for each of the plurality of nodes comprises a chart or coded map that visually represents amounts and quantities of resource notes at each of the plurality of nodes across the physical geographic region.

5. The system of claim 1, wherein the visual representation of the reconciled monitored data for each of the plurality of nodes comprises a chart or coded map that visually represents a progression of an individual resource note of the plurality of resource notes across the plurality of nodes in the physical geographic region, based on the unique identifier associated with the individual resource note.

6. The system of claim 1, wherein the one or more processing devices are further configured to execute computer-readable program code to:
determine a trend of an amount of the plurality of resource notes that are present at a first node of the plurality of nodes over a period of time;
determine, based on the trend, a predicted amount of the plurality of resource notes that are expected to be present at the first node at a future point in time; and
generate a visual representation of the determined predicted amount of the plurality of resource notes that are expected to be present at the first node at the future point in time.

7. The system of claim 1, wherein each of the plurality of nodes comprise one or more automated teller machines, point of sale devices, mobile devices associated with users, delivery vehicles, or merchant locations.

8. A computer program product for providing a resource grid system for tracking and reconciling resource movement, the computer program product comprising at least one non-transitory computer readable medium comprising computer readable instructions, the instructions comprising instructions for:
monitoring, continuously, a plurality of resource notes at a plurality of nodes across a physical geographic region, wherein monitoring comprises:
determining when each of the plurality of resource notes are received at each of the plurality of nodes and automatically scanning each of the plurality of resource notes for a unique identifier associated with each of the plurality of resource notes in real-time as they are received, wherein the unique identifier is associated with a unique characteristic and a denomination associated with each of the plurality of resource notes;
determining when each of the plurality of resource notes are dispensed at each of the plurality of nodes and automatically scanning each of the plurality of resource notes for the unique identifier associated with each of the plurality of resource notes in real-time as they are dispensed; and
storing monitored data for each of the plurality of nodes in a resource grid database, wherein the monitored data comprises nodal location data, time data associated with the received and the dispensed resource notes, unique identifier data for each of the received and the dispensed resource notes, and denomination data for each of the plurality of the received and the dispensed resource notes;
reconciling, automatically, the monitored data for each of the plurality of nodes in real-time; and
providing a visual representation of the reconciled monitored data for each of the plurality of nodes to a computing device of a user.

9. The computer program product of claim 8, wherein the computer readable instructions further comprise instructions for:
determining, from the scan of the plurality of resource notes for the unique identifier as they are received, that a first received resource note does not comprise a respective unique identifier;
in response to determining that the first received resource note does not comprise the respective unique identifier, extracting identifiable data from the scan of the first received resource note; and
applying the unique identifier to the first received resource note.

10. The computer program product of claim 9, wherein applying the unique identifier comprises stamping, printing, or placing a number, a code, a text, an icon, or an image directly onto the first received resource note.

11. The computer program product of claim 8, wherein the visual representation of the reconciled monitored data for each of the plurality of nodes comprises a chart or coded map that visually represents amounts and quantities of resource notes at each of the plurality of nodes across the physical geographic region.

12. The computer program product of claim 8, wherein the visual representation of the reconciled monitored data for each of the plurality of nodes comprises a chart or coded map that visually represents a progression of an individual resource note of the plurality of resource notes across the plurality of nodes in the physical geographic region, based on the unique identifier associated with the individual resource note.

13. The computer program product of claim 8, wherein the computer readable instructions further comprise instructions for:
determining a trend of an amount of the plurality of resource notes that are present at a first node of the plurality of nodes over a period of time;
determining, based on the trend, a predicted amount of the plurality of resource notes that are expected to be present at the first node at a future point in time; and
generating a visual representation of the determined predicted amount of the plurality of resource notes that are expected to be present at the first node at the future point in time.

14. The computer program product of claim 8, wherein each of the plurality of nodes comprise one or more automated teller machines, point of sale devices, mobile devices associated with users, delivery vehicles, or merchant locations.

15. A computer implemented method for providing a resource grid system for tracking and reconciling resource movement, said computer implemented method comprising:
monitoring, continuously, a plurality of resource notes at a plurality of nodes across a physical geographic region, wherein monitoring comprises:
determining when each of the plurality of resource notes are received at each of the plurality of nodes and automatically scanning each of the plurality of resource notes for a unique identifier associated with each of the plurality of resource notes in real-time as they are received, wherein the unique identifier is associated with a unique characteristic and a denomination associated with each of the plurality of resource notes;
determining when each of the plurality of resource notes are dispensed at each of the plurality of nodes and automatically scanning each of the plurality of resource notes for the unique identifier associated with each of the plurality of resource notes in real-time as they are dispensed; and
storing monitored data for each of the plurality of nodes in a resource grid database, wherein the monitored data comprises nodal location data, time data associated with the received and the dispensed resource notes, unique identifier data for each of the received and the dispensed resource notes, and denomination data for each of the plurality of the received and the dispensed resource notes;
reconciling, automatically, the monitored data for each of the plurality of nodes in real-time; and
providing a visual representation of the reconciled monitored data for each of the plurality of nodes to a computing device of a user.

16. The computer implemented method of claim 15, further comprising:
determining, from the scan of the plurality of resource notes for the unique identifier as they are received, that a first received resource note does not comprise a respective unique identifier;
in response to determining that the first received resource note does not comprise the respective unique identifier, extracting identifiable data from the scan of the first received resource note; and
applying the unique identifier to the first received resource note.

17. The computer implemented method of claim 16, wherein the visual representation of the reconciled monitored data for each of the plurality of nodes comprises a chart or coded map that visually represents amounts and quantities of resource notes at each of the plurality of nodes across the physical geographic region.

18. The computer implemented method of claim 15, wherein the visual representation of the reconciled monitored data for each of the plurality of nodes comprises a chart or coded map that visually represents a progression of an individual resource note of the plurality of resource notes across the plurality of nodes in the physical geographic region, based on the unique identifier associated with the individual resource note.

19. The computer implemented method of claim 15, further comprising:
determining a trend of an amount of the plurality of resource notes that are present at a first node of the plurality of nodes over a period of time;
determining, based on the trend, a predicted amount of the plurality of resource notes that are expected to be present at the first node at a future point in time; and
generating a visual representation of the determined predicted amount of the plurality of resource notes that are expected to be present at the first node at the future point in time.

20. The computer implemented method of claim 15, wherein each of the plurality of nodes comprise one or more automated teller machines, point of sale devices, mobile devices associated with users, delivery vehicles, or merchant locations.
